(19) United States
(12) Patent Application Publication
(10) Pub. No.: US 2008/0276918 A1
(43) Pub. Date: Nov. 13, 2008

(54) INTEGRATED IGNITION COIL AND OIL SEAL FOR HEAD AND CAM COVER

(76) Inventors: Albert A. Skinner, El Paso, TX (US); Colin J. Hamer, El Paso, TX (US)

Correspondence Address: DELPHI TECHNOLOGIES, INC., M/C 480-410-202, PO BOX 5052, TROY, MI, 48007, US

(21) Appl. No.: 11/747,600

(22) Filed: May 11, 2007

(51) Int. Cl. F02P 3/02

(52) U.S. Cl. 123/635

(57) ABSTRACT

An ignition apparatus includes an oil seal integrated with a spark plug boot and configured to mate with a cylinder head so as to seal the oil that is found under the cam cover from the spark plug and high voltage terminal of the plug. The cylinder head includes a ring-cavity recessed in the head surrounding the spark plug. The spark plug boot includes an annular sealing rib on a lowermost axial end. The sealing rib is configured in size and shape to effect an interference fit in the ring cavity. The ignition apparatus includes another seal integrated at the top to seal to the cam cover. The two integrated seals eliminate the need for a spark plug tube.

### BACKGROUND OF THE INVENTION

1. Technical Field

The present invention relates generally to an ignition apparatus or coil, and, more particularly, to an integrated ignition coil and oil seal for head and cam cover.

2. Discussion of the Background Art

Ignition coils utilize primary and secondary windings and a magnetic circuit. The magnetic circuit may include a central core formed of magnetically-permeable material and a side core or shield, tubular in shape, formed of silicon steel, as seen by reference to U.S. Pat. No. 6,437,674 issued to Hamer et al. Hamer et al. further disclose an ignition coil having a relatively slender configuration adapted for mounting directly above a spark plug in a spark plug well-commonly referred to as a “pencil” coil.

The spark plug well tube is typically very small in diameter, requiring that the conventional ignition coil, including the integral shield, fit inside. The spark plug well tube is conventionally formed of steel, but is known to be made out of aluminum or other materials. The spark plug well may either be cast into the aluminum head or take the form of a tube pressed into the head (“press fit”). In conventional ignition coil design, the shield referred to above is needed external to the central components (i.e., central core, windings, etc.) to complete the magnetic circuit. Since the shield itself may comprise multiple layers having a total thickness of about 0.40 mm to 1.40 mm per side, such space is unavailable for use in increasing the core material, increasing dielectric thickness, and the like.

Ignition coils that are designed to fit into a spark plug well (“pencil coils”), typically have a silicone rubber boot to interface to the spark plug and a silicone rubber seal to keep water from entering into the spark plug well.

For example, FIG. 1 is typical of the art, which shows an ignition system 110 with an ignition coil 111 disposed within a spark plug well 112. In FIG. 1, well 112 extends between a cam cover 113 and an engine head portion 114 of an internal combustion engine. Depending on the engine design, however, the extent of the spark plug well 112 may vary. A conventional spark plug 115 is also shown. In order to reduce cost and weight of modern engines, the press-fit tube configuration described above is becoming more common.

Further, as known, actuating mechanisms (e.g., camshaft) for opening and closing engine valves (shown in block form, designated 116) may be disposed in the interior space between the engine head and the cam cover. Lubricating oil is provided in the interior space for lubrication of the moving components. The spark plug well/press fit tube provides a barrier such that the spark plug is isolated from the lubricating oil, which if allowed to contact the spark plug or other energized portions of the ignition apparatus, could result in electrical shorts of the type which may result in misfire or other problems. The function of the tube is thus to seal the oil in the interior space between the head and the cam cover. However, the tube is a separate component carrying with it a cost, size and weight penalty.

Moreover, in tight space configurations, the diameter of the spark plug well is such that a pencil coil arrangement cannot be used, and a so-called plug top coil must be used (i.e., where the transformer is substantially above the spark plug well in the engine compartment). However, the use of a plug top ignition coil can create packaging issues in size constrained engine compartment configurations. A feature of a “pencil” coil on the other hand is that a substantial portion of the transformer (i.e., a central core and primary and secondary windings) is located within the spark plug well itself, thereby improving space utilization in an engine compartment.

There is therefore a need for an ignition apparatus or coil that minimizes or eliminates one or more of the problems as set forth above.

### SUMMARY OF THE INVENTION

One advantage of the present invention is that it seals the spark plug from the lubricating oil, thus eliminating the need for a spark plug well (i.e., in the form of a press fit tube or otherwise), which decreases weight and cost, and frees up valuable space in the interior under the cam cover. As a consequence, another advantage is that the increased interior space may allow for the use of a pencil coil in certain situations instead of a plug top ignition coil. This arrangement also potentially eases packaging issues in an engine compartment that with conventional approaches a plug top coil would be needed but with the present invention a pencil coil can be used.

Additionally, the added space (e.g., 2-3 mm diameter under the cam cover) may be used for enlarging the ignition coil (e.g., increasing performance).

An ignition apparatus for an internal combustion engine having a cam cover enclosing engine valves, actuation therefor, and at least a spark plug engaged in a cylinder head includes an elongated transformer assembly, a case and a spark plug boot. The elongated transformer assembly is configured to generate a spark voltage and has a longitudinal axis. The case is configured to house the transformer assembly. The case includes a high-voltage (HV) connection at a first end thereof configured for direct mounting on the spark plug.

The spark plug boot surrounds a portion of the case and comprises electrical insulating material. The cylinder head includes a first feature disposed therein which surrounds the spark plug. The spark plug boot includes a second feature on an axial end thereof near the HV connection. The first and second features are complementary so as to form a sealing arrangement of the spark plug boot to the cylinder head. The seal functions to seal the lubricating oil in the interior space under the cam cover and to prevent it from reaching the spark plug or HV connection inside the spark plug boot.

In one embodiment, the first feature comprises a ring cavity recessed in the cylinder head and the second feature comprises an annular sealing rib. The sealing rib is configured in size and shape to effect an interference fit in the ring cavity. The ignition apparatus also includes a second sealing arrangement at the upper axial end configured to seal the ignition apparatus to the cam cover. The second sealing arrangement is configured, among other things, to keep water out of the interior space under the cam cover.

Other features and advantages of the present invention are presented.

### BRIEF DESCRIPTION OF THE DRAWINGS

The present invention will now be described by way of example, with reference to the accompanying drawings, in which:

FIG. 1 is a prior art spark plug well arrangement showing a spark plug tube press fit into a circular recess concentrically disposed around the spark plug opening.

FIG. 2 is a partial, simplified cross-section view of an ignition apparatus having integrated oil seals for the cylinder head and the cam cover.

### DETAILED DESCRIPTION OF THE PREFERRED EMBODIMENTS

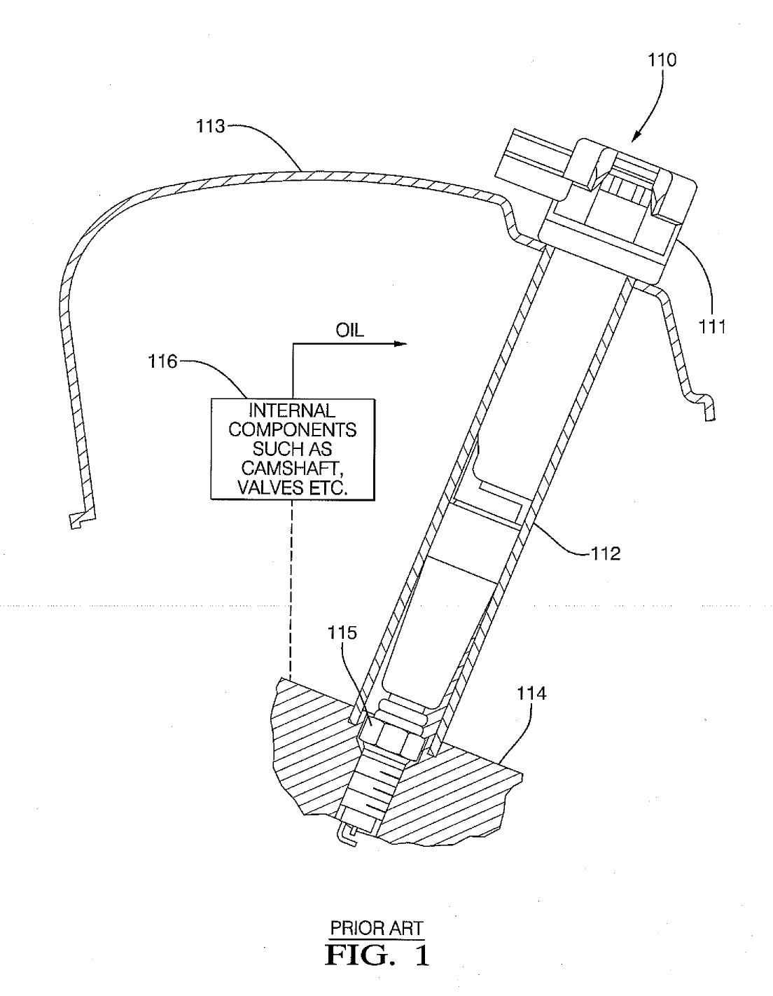

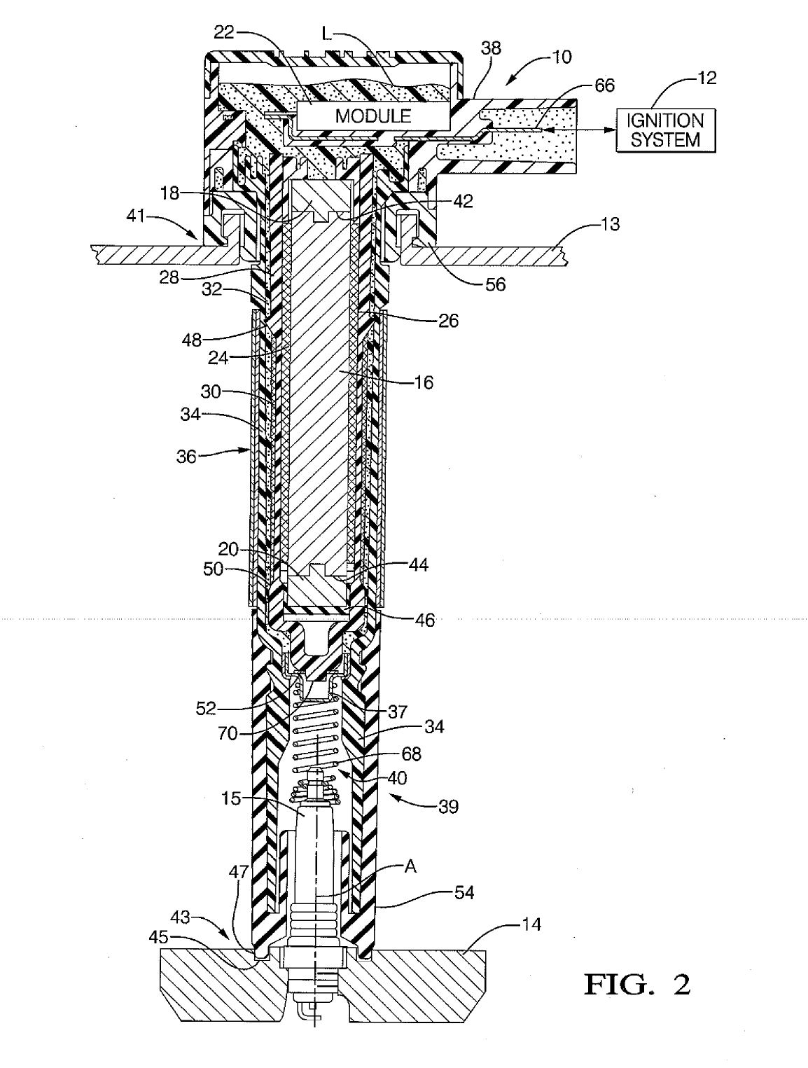

Referring now to the drawings wherein like reference numerals are used to identify identical components in the various views, FIG. 2 is a simplified, cross-sectional view of an ignition apparatus or coil 10 in accordance with the present invention. As is generally known, ignition apparatus 10 may be coupled to, for example, an ignition system 12, which may contain primary energization circuitry for controlling the charging and discharging of ignition apparatus 10. The ignition apparatus 10 is provided for use with an internal combustion engine of the type having a valve or cam cover or the like (e.g., cover 13) enclosing engine valves, actuation therefor such as a camshaft (as shown by block 116, FIG. 1), and a spark plug 15 engaged in a cylinder head 14, which may be retained by a threaded engagement with a spark plug opening into the combustion cylinder. As is well known, the relatively high voltage produced by ignition apparatus 10 is provided to spark plug 15 (shown in phantom-line format in FIG. 2) for producing a spark across a spark gap thereof, which may be employed to initiate combustion in a combustion chamber of the engine. The engine may provide power for locomotion of a vehicle, as known. Ignition system 12 and spark plug 15 perform conventional functions well known to those of ordinary skill in the art.

FIG. 2 shows a central core 16, an optional first magnet 18, an optional second magnet 20, an electrical module 22, a primary winding 24, a first layer of encapsulant such as an epoxy potting material layer 26, a secondary winding spool 28, a secondary winding 30, a second layer 32 of epoxy potting material, a case 34, a shield 36, an electrically conductive cup 37, a low-voltage (LV) connector body 38, and a high-voltage (HV) connector assembly 40. Core 16 includes top end 42 and bottom end 44. FIG. 2 further shows a rubber buffer cup 46, annular portions 48, 50, high voltage terminal 52, and a spark plug boot 54.

Generally, the core 16, primary and secondary windings 24, 30, and the shield 36 (i.e., outer magnetic core) define a high voltage transformer assembly configured to generate a spark voltage for the plug 15. The core 16 is elongated and includes a main, longitudinal axis “A”. The primary and secondary windings 24, 30 are generally radially outwardly of the core 16.

The case 34 is configured to house the transformer assembly and includes a high-voltage (HV) connection 39 at a first axial end thereof configured for direct mounting on the spark plug 15 (as shown). The HV connection is surrounded by portion 34_{HV} (e.g., as shown, the axially lowermost portion of case 34) and includes an HV connector assembly 40 for electrically connecting to the spark plug 15. The spark plug boot 54 surrounds portion 34_{HV} and comprises electrical insulating material, such as silicone rubber.

The inventive ignition apparatus includes dual oil sealing arrangements, one sealing arrangement for sealing to the cam cover 13, and a second sealing arrangement for sealing to the cylinder head 14. Through these sealing arrangements, the conventional use of a spark plug well tube may be eliminated.

FIG. 2 shows a first sealing arrangement 41 disposed at the top, axial end of the case 34. The first sealing arrangement 41 is configured to seal the ignition apparatus 10 to the cam cover 13. Sealing arrangement 41 may comprise a conventional seal known in the art that seals the ignition apparatus (or case) to the cam cover 13. For merely exemplary purposes only, the sealing arrangement 41 may take the form of a seal member 56 as shown in FIG. 2 that is configured to mate with a corresponding configuration of the cam cover 13 such that an effective oil seal is formed. Sealing arrangement 41 is impervious to and seals heated lubricating oil in the interior under the cam cover 13. Additionally, sealing arrangement 41 seals out water. First sealing arrangement 41 may comprise silicone rubber or other suitable materials known in the art. It should be understood that there are a wide range of comparable sealing arrangements known in the art for sealing to the cam cover 13, and fall within the spirit and scope of the present invention.

FIG. 2 further shows a second sealing arrangement 43 where the spark plug boot 54 seals to the cylinder head 14. To implement the second sealing arrangement 43, the cylinder head 14 includes a first feature such as a circular shaped ring cavity 45 recessed in the head 14, disposed to circumscribe the spark plug opening. The second sealing arrangement 43 further includes a second feature such as an annular sealing rib 47 integral with and extending axially away from the lowermost end of the spark plug boot 54. The first and second features 45, 47 are, in general, complementary so as to form the second sealing arrangement 43 configured to seal the boot 54 with the cylinder head 14. In the illustrated embodiment, the annular sealing rib 47 is configured in size and shape to effect an interference fit in the ring cavity 45, thereby ensuring a seal impervious to and thus sufficient to keep oil under the cam cover from penetrating and contacting spark plug, as described in the Background. The boot 54 may comprise electrical insulating material such as silicone rubber, or other suitable materials known in the art.

Through the foregoing integrated oil sealing arrangements, the conventionally used spark plug well tube can be eliminated, thus freeing up 2-3 mm in diameter under the cam cover. This additional space, for example, may have the principal advantage of allowing use of a pencil coil where only a plug top coil would have spatially fit if a spark plug well tube were used, as described in the Background.

With continuing reference to FIG. 2, further details concerning ignition apparatus 10 will now be set forth configured to enable one to practice the present invention. It should be understood that portions of the following are exemplary only and not limiting in nature. Many other configurations are known to those of ordinary skill in the art and are consistent with the teachings of the present invention. Core 16 may be elongated, having a main, longitudinal axis “A” associated therewith. Core 16 includes an upper, first end 42, and a lower, second end 44. Core 16 may be a conventional core known to those of ordinary skill in the art. As illustrated, core 16, in the preferred embodiment, takes a generally cylindrical shape (which is a generally circular shape in radial cross-section), and may comprise compression molded insulated iron particles or laminated steel plates, both as known.

Magnets 18 and 20 may be included in ignition apparatus 10 as part of the magnetic circuit, and provide a magnetic bias for improved performance. The construction of magnets such as magnets 18 and 20, as well as their use and effect on performance, is well understood by those of ordinary skill in the art. It should be understood that magnets 18 and 20 are optional in ignition apparatus 10, and may be omitted, albeit with a reduced level of performance, which may be acceptable, depending on performance requirements. A rubber buffer cup 46 may be included.

Primary winding 24 may be wound directly onto core 16 in a manner known in the art. Primary winding 24 includes first and second ends and is configured to carry a primary current Iₚ for charging apparatus 10 upon control of ignition system 12. Winding 24 may be implemented using known approaches and conventional materials. Although not shown, primary winding 24 may be wound on a primary winding spool (not shown) in certain circumstances (e.g., when steel laminations are used).

Layers 26 and 32 comprise an encapsulant suitable for providing electrical insulation within ignition apparatus 10. In a preferred embodiment, the encapsulant comprises epoxy potting material. The epoxy potting material introduced in layers 26, and 32 may be introduced into annular potting channels defined (i) between primary winding 24 and secondary winding spool 28, and, (ii) between secondary winding 30 and case 34. The potting channels are filled with potting material, in the illustrated embodiment, up to approximately the level designated “L” in FIG. 2. A variety of other thicknesses are possible depending on flow characteristics and insulating characteristics of the encapsulant and the design of the apparatus 10. The potting material also provides protection from environmental factors which may be encountered during the service life of ignition apparatus 10. There is a number of suitable epoxy potting materials well known to those of ordinary skill in the art.

Secondary winding spool 28 is configured to receive and retain secondary winding 30. Spool 28 is disposed adjacent to and radially outwardly of the central components comprising core 16, primary winding 24, and epoxy potting layer 26, and, preferably, is in coaxial relationship therewith. Spool 28 may comprise any one of a number of conventional spool configurations known to those of ordinary skill in the art. In the illustrated embodiment, spool 28 is configured to receive one continuous secondary winding (e.g., progressive winding) on an outer surface thereof, as is known. However, it should be understood that other configurations may be employed, such as, for example only, a configuration adapted for use with a segmented winding strategy (e.g., a spool of the type having a plurality of axially spaced ribs forming a plurality of channels therebetween for accepting windings) as known.

The depth of the secondary winding in the illustrated embodiment may decrease from the top of spool 28 (i.e., near the upper end 42 of core 16), to the other end of spool 28 (i.e., near the lower end 44) by way of a progressive gradual flare of the spool body. The result of the flare or taper is to increase the radial distance (i.e., taken with respect to axis “A”) between primary winding 24 and secondary winding 30, progressively, from the top to the bottom. As is known in the art, the voltage gradient in the axial direction, which increases toward the spark plug end (i.e., high voltage end) of the secondary winding, may require increased dielectric insulation between the secondary and primary windings, and, may be provided for by way of the progressively increased separation between the secondary and primary windings.

Spool 28 is formed generally of electrical insulating material having properties suitable for use in a relatively high temperature environment. For example, spool 28 may comprise plastic material such as PPO/PS (e.g., NORYL available from General Electric) or polybutylene terephthalate (PBT) thermoplastic polyester. It should be understood that there are a variety of alternative materials that may be used for spool 28 known to those of ordinary skill in the ignition art, the foregoing being exemplary only and not limiting in nature.

Spool 28 may further include a first and second annular feature 48 and 50 formed at axially opposite ends thereof. Features 48 and 50 may be configured so as to engage an inner surface of case 34 to locate, align, and center the spool 28 in the cavity of case 34.

As described above, spool 28 includes an electrically conductive (i.e., metal) high-voltage (HV) terminal 52 disposed therein configured to engage cup 37, which in turn is electrically connected to the HV connector assembly 40. The body of spool 28 at a lower end thereof is configured so as to be press-fit into the interior of cup 37 (i.e., the spool gate portion).

FIG. 2 also shows secondary winding 30 in cross-section. Secondary winding 30, as described above, is wound on spool 28, and includes a low voltage end and a high voltage end. The low voltage end may be connected to ground by way of a ground connection through LV connector body 38 in a manner known to those of ordinary skill in the art. The high voltage end is connected to HV terminal 52. Winding 30 may be implemented using conventional approaches and materials known to those of ordinary skill in the art.

Case 34 includes an inner, generally enlarged cylindrical surface, an outer surface, a first annular shoulder, a flange, an upper through-bore, and a lower through bore.

The inner surface of case 34 is configured in size to receive and retain spool 28 which contains the core 16 and primary winding 24. The inner surface of case 34 may be slightly spaced from spool 28, particularly the annular spacing features 48, 50 thereof (as shown), or may engage the spacing features 48, 50.

A lower through bore of case 34 is defined by an inner surface thereof configured in size and shape (i.e., generally cylindrical) to provide a press fit with an outer surface of cup 37 at a lowermost portion thereof as described above. When the lowermost body portion of spool 28 is inserted in the lower bore containing cup 37, HV terminal 52 engages an inner surface of cup 37 (also via a press fit).

Case 34 is formed of electrical insulating material, and may comprise conventional materials known to those of ordinary skill in the art (e.g., the PBT thermoplastic polyester material referred to above).

Shield 36 is generally annular in shape and is disposed radially outwardly of case 34, and, preferably, engages an outer surface of case 34. The shield 36 preferably comprises electrically conductive material, and, more preferably metal, such as silicon steel or other adequate magnetic material. Shield 36 provides not only a protective barrier for ignition apparatus 10 generally, but, further, provides a magnetic path for the magnetic circuit portion of ignition apparatus 10. Shield 36 may nominally be about 0.50 mm thick, in one embodiment. Shield 36 may be grounded by way of an internal grounding strap, finger or the like (not shown) well know to those of ordinary skill in the art. Shield 36 may comprise multiple, individual sheets 36, as shown.

Low voltage connector body 38 is configured to, among other things, electrically connect the first and second ends of primary winding 24 to an energization source, such as, the energization circuitry included in ignition system 12. Connector body 38 is generally formed of electrical insulating material, but also includes a plurality of electrically conductive output terminals 66 (e.g., pins for ground, primary winding leads, etc.). Terminals 66 are coupled electrically, internally through connector body 38, in a manner known to those of ordinary skill in the art, and are thereafter connected to various parts of apparatus 10, also in a manner generally know to those of ordinary skill in the art.

HV connector assembly 40 may include a spring contact 68 or the like, which is electrically coupled to cup 37. Contact spring 68 is in turn configured to engage a high-voltage connector terminal of spark plug 15. This arrangement for coupling the high voltage developed by secondary winding 30 to plug 15 is exemplary only; a number of alternative connector arrangements, particularly spring-biased arrangements, are known in the art.

The present invention provides for integrated oil seals in an ignition apparatus which effectively allows for the elimination of the spark plug well tube. The additional space thus recaptured allows for the use of a pencil coil where only a plug-top coil may have been an option, absent the invention.

1. An ignition apparatus for an internal combustion engine having a cam cover enclosing engine valves, actuation therefor, and at least a spark plug engaged in an opening in a cylinder head, comprising:
an elongated transformer assembly configured to generate a spark voltage and having a longitudinal axis associated therewith;
a case configured to house said transformer assembly, said case including a high-voltage (HV) connection at a first end thereof configured for direct mounting on the spark plug;
a spark plug boot surrounding a portion of said case and comprising electrical insulating material, wherein the cylinder head includes a first feature disposed therein surrounding the spark plug opening, said boot including a second feature on an axial end thereof proximate said HV connection, said first and second features being complementary so as to form a sealing arrangement of said spark plug boot with said cylinder head.

2. The ignition apparatus of claim 1 wherein said electrical insulating material comprises silicone rubber.

3. The ignition apparatus of claim 1 wherein said ignition apparatus comprises a pencil ignition coil.

4. The ignition apparatus of claim 1 wherein said first feature comprises a circular-shaped ring cavity recessed in the cylinder head and circumscribing said spark plug opening in which the spark plug is engaged, said second feature comprises an annular sealing rib extending axially from said axial, lowermost end of said spark plug boot, said annular sealing rib being configured in size and shape to effect an interference fit in said ring cavity.

5. The ignition apparatus of claim 1 wherein said sealing arrangement is a first sealing arrangement, said apparatus further including a second sealing arrangement configured to seal said ignition apparatus to the cam cover.

6. The ignition apparatus of claim 5 wherein the first and second sealing arrangements are impervious to lubricating oil.

7. An ignition apparatus for an internal combustion engine having a cam cover enclosing engine valves, actuation therefor, and at least a spark plug engaged in an opening in a cylinder head, comprising:
a transformer assembly including a central core, a primary and a secondary winding, and an outer core, said central core being elongated and having a main axis, said primary and secondary windings being disposed radially outwardly of said central core;
a case configured to house said transformer assembly, said case including a high-voltage (HV) connection at a first axial end thereof configured for direct mounting on the spark plug, wherein said HV connection comprises a high-voltage (HV) connector assembly for electrically connecting to the spark plug;
a spark plug boot surrounding a portion of said case and comprising electrical insulating material;
a first sealing arrangement disposed opposite said first axial end configured to seal said ignition apparatus to said cam cover;
wherein the cylinder head includes a first feature disposed therein surrounding the spark plug opening, said spark plug boot including a second feature on an axial end thereof proximate said HV connection, said first and second features being complementary so as to form a second sealing arrangement configured to seal said spark plug boot with said cylinder head.

8. The apparatus of claim 7 wherein said electrical insulating material comprises silicone rubber.

9. The apparatus of claim 7 wherein said ignition apparatus comprises a pencil ignition coil.

10. The apparatus of claim 7 wherein said first feature comprises a circular-shaped ring cavity recessed in the cylinder head and circumscribing said spark plug opening in which the spark plug is retained, said second feature comprises an annular sealing rib extending axially from said axial, lowermost end of said spark plug boot, said annular sealing rib being configured in size and shape to effect an interference fit in said ring cavity.

11. The apparatus of claim 7 wherein said first and second sealing arrangements are impervious to lubricating oil.

12. The apparatus of claim 7 wherein said first sealing arrangement is impervious to water.
